(19) United States
(12) Patent Application Publication
(10) Pub. No.: US 2024/0227694 A9
(43) Pub. Date: Jul. 11, 2024

(54) Tool Organizer For Vehicle

(71) Applicant: David Convertini, Clarence, NY (US)

(72) Inventor: David Convertini, Clarence, NY (US)

(21) Appl. No.: 18/048,282

(22) Filed: Oct. 20, 2022

(51) Int. Cl. B60R 11/06

(52) U.S. Cl. CPC B60R 11/06; B60R 2011/0017

(57) ABSTRACT

A tool organizer for a vehicle, comprising a frame, the frame comprising a first U-shaped member and a second U-shaped member facing and fixedly secured to the first U-shaped member, the second U-shaped member arranged to engage headrest posts in the vehicle.

### FIELD

The present invention relates generally to tool organizers and, more specifically, to tool organizers for vehicles.

### BACKGROUND

Craftsman, including contractors, carpenters, plumbers, electricians and handymen, frequently travel from job site to job site, often in cars, trucks and/or vans. They often carry a variety of tools with them, as they need to be prepared to perform a variety of jobs. The number and variety of tools they carry is many and varied, including manual tools and power tools, pneumatic, manual and electric. They carry power screwdrivers and drills, hammers, staple guns and nail guns, to name but a few. They carry extra batteries for their tools and chargers for those batteries. Regardless of the number and variety of the tools they carry, organization of those tools, both during transit and at the job site, is critical. It is inefficient and perhaps even dangerous to simply store these tools on the seat or floor of a vehicle.

The need to organize items and articles in vehicles is not new. From fast food to apparel to magazines, others have noticed and attempted to solve similar problems over the years, albeit not apparently to organize the tools of a craftsman.

For example, U.S. Pat. No. 3,986,649 (Frederick A. Heimstra) (1976) discloses a storage bin for loose articles, adapted to be atop a vehicle seat (such as a headrest) other upright support. Heimstra's invention attempts to solve the problem of storing “loose articles” scattered about the passenger compartment of a vehicle. He doesn't specifically mention tools, but he does mention maps, magazines, pens, pencils, crayons and books. Although Heimstra's invention might make it possible to hold some small, lightweight tools, it does not appear to be structurally and functionally capable of holding and organizing heavier tools that would be used by a contractor. Specifically, this patented invention merely atop a head rest of a vehicle and does not appear to offer a stable support structure during transit.

U.S. Pat. No. D419,520 (James Bergh) (2000) discloses a vehicle backseat organizer. The patent illustrates that this organizer is secured about both the headrest and the back of the seat itself. The organizer does not appear to be structurally and functionally capable of holding and organizing heavier tools that would be used by a contractor.

U.S. Pat. No. 6,439,443 (Michael Liao) (2002) discloses a “car butler” to store and hold articles in a vehicle. The inventor seems quite concerned with transporting takeout food from restaurant to home! His patent teaches supporting a frame by attachment to the headrest post, but the invention also includes an additional member to support the butler against the seatback.

U.S. Pat. No. 7,891,733 (Christopher Clarke) (2011) discloses a “backseat plan holder” arranged to be secured either to the front or rear of a vehicle seat using a couple of straps. One of his “points of novelty” appears to be the triangular shape of the openings in the organizer, specifically designed to hold “blueprints” and the like. There is no teaching in this patent of securing the organizer to the headrest supports of a vehicle.

U.S. Pat. No. 10,214,130 (John DeLeon) (2019) discloses and patented a collapsible organizer for in-vehicle storage. The patent teaches a cantilever element arranged to engage the headrest support posts and suspend the organizer in a cantilevered manner. The inventor seems more concerned with transporting food and electronic devices than tools.

U.S. Published Patent Application No. 2015/0183379 (Kevin Hensley) (2015) discloses a hat holder. The C-shaped holder is very simple in structure. The invention includes a couple of straps that surround the headrest, each of which includes a sleeve to accommodate a prong of the holder.

PCT international Patent Application No. PCT/NL99/00712 (Camiel Hofstee) (1999) discloses a coat hanger for fastening to the headrest of a vehicle seat. This patent application expressly teaches securing the device to the headrest posts inside a vehicle.

Thus, although others have appreciated a need for transporting and organizing some articles and items in a vehicle, there remains a need for a more efficient and better organizer for tools for a vehicle.

### SUMMARY OF THE INVENTION

The present invention broadly comprises a tool organizer for a vehicle, comprising a frame, the frame comprising a first U-shaped member arranged perpendicularly to ground, the first U-shaped member having a first section, a second section and a middle section arranged between the first and second sections, wherein the first and second sections are arranged parallel and in registration with one another and substantially perpendicular to the middle section, a second member arranged perpendicularly to the middle section and fixedly secured thereto at a first location of the middle section, a third member arranged perpendicularly to the middle section and fixedly secured thereto at a second location of the middle section, such that the second and third members are substantially parallel to and spaced apart from one another, a fourth member arranged substantially parallel to and spaced apart from the middle section of the first member and substantially parallel to the ground, the fourth member fixedly secured to the second member and also fixedly secured to the third member, a fifth member arranged substantially parallel to the middle section of the first member and spaced apart therefrom, the fifth member fixedly secured to the second member and also arranged parallel to and spaced apart from the fourth member, and, a sixth member arranged substantially parallel to the middle section of the first member and spaced apart therefrom, the sixth member fixedly secured to the third member and also arranged parallel to and spaced apart from the fourth member. The organizer also includes an optional strap to secure it in place during use.

The invention also broadly comprises a tool organizer for a vehicle, comprising a frame, the frame comprising a first U-shaped member and a second U-shaped member facing and fixedly secured to the first U-shaped member, the second U-shaped member arranged to engage headrest posts in the vehicle.

A primary object of the present invention is to provide a tool organizer for a vehicle.

Another object of the present invention is to provide a tool organizer for a vehicle that easily secures to headrest posts in the vehicle.

These and other objects, features, and advantages of the present invention will become readily apparent upon a review of the following detailed description of the invention, in view of the drawings and appended claims.

### BRIEF DESCRIPTION OF DRAWINGS

Various embodiments are disclosed, by way of example only, with reference to the accompanying drawings, in which corresponding reference symbols indicate corresponding parts, in which:

FIG. 1 is a perspective view of the tool organizer of the present invention;

FIG. 2 is a perspective view, similar to the view in FIG. 1, except showing the organizer in place in a vehicle, with the headrest of the vehicle raised to permit viewing the tool organizer engagement with the headrest posts, and also showing the tools and optional strap removed from the organizer;

FIG. 3 is a perspective view of the tool organizer of the present invention shown in place in a vehicle and functioning to hold three tools;

FIG. 4 is an exploded view of the tool organizer shown in FIG. 2;

FIG. 4 is a rear perspective view of the tool organizer of the present invention;

FIG. 5 is a top view of the tool organizer shown in FIG. 4;

FIG. 6A is a right elevational view of the tool organizer shown in FIG. 4;

FIG. 6B is a left elevational view of the tool organizer shown in FIG. 4;

FIG. 7A is a rear elevational view of the tool organizer shown in FIG. 4; and,

FIG. 7B is a front elevational view of the tool organizer shown in FIG. 4.

### DETAILED DESCRIPTION

At the outset, it should be appreciated that like drawing numbers on different drawing views identify identical, or functionally similar, structural elements. It is to be understood that the claims are not limited to the disclosed aspects.

Furthermore, it is understood that this disclosure is not limited to the particular methodology, materials and modifications described and as such may, of course, vary. It is also understood that the terminology used herein is for the purpose of describing particular aspects only and is not intended to limit the scope of the claims.

Unless defined otherwise, all technical and scientific terms used herein have the same meaning as commonly understood to one of ordinary skill in the art to which this disclosure pertains. It should be understood that any methods, devices or materials similar or equivalent to those described herein can be used in the practice or testing of the example embodiments.

It should be appreciated that the term “substantially” is synonymous with terms such as “nearly,” “very nearly,” “about,” “approximately,” “around,” “bordering on,” “close to,” “essentially,” “in the neighborhood of,” “in the vicinity of,” etc., and such terms may be used interchangeably as appearing in the specification and claims.

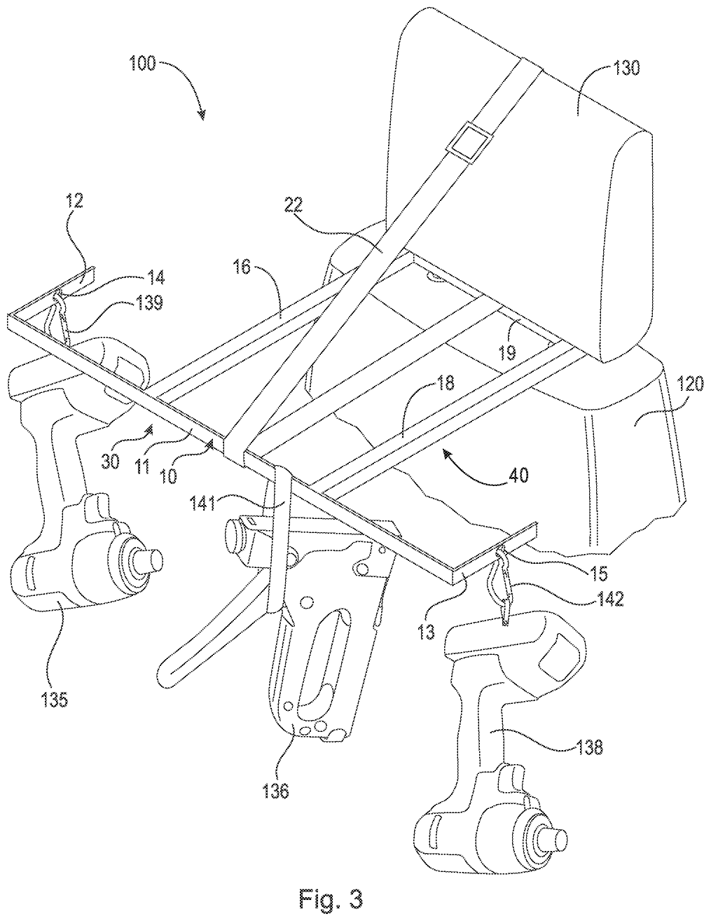

Adverting now to FIG. 3, tool organizer 100 is shown in a perspective view in place in a vehicle functioning to hold three tools (two power drivers 135 and 136 and stapler 138). The tool organizer is shown secured between headrest 130 and seat back 120 and extending outwardly in a cantilevered manner. FIG. 3 illustrates the tool organizer secured to the front of a rear seat of a vehicle, such as a pickup truck, but it should be appreciated that the organizer could also be easily secured to the rear of a front seat of a vehicle. Tool organizer 100 broadly includes frame 10. The frame includes first U-shaped member 30 arranged perpendicularly to ground (by “perpendicular to ground” it is meant that member 30 comprises flat bar and the flat bar is arranged perpendicular to the ground which supports the vehicle), the first U-shaped member having first section 12, second section 13 and middle section 11 arranged between the first and second sections, wherein the first and second sections are arranged parallel and in registration with one another and substantially perpendicular to the middle section, second member 16 arranged perpendicularly to middle section 11 and fixedly secured thereto at a first location of middle section 11, third member 18 arranged perpendicularly to middle section 11 and fixedly secured thereto at a second location of middle section 11, such that the second and third members are substantially parallel to and spaced apart from one another, fourth member 19 arranged substantially parallel to and spaced apart from middle section 11 of first member 30 and substantially parallel to the ground, the fourth member fixedly secured to second member 16 and also fixedly secured to third member 18, fifth member 20 arranged substantially parallel to the middle section of the first member and spaced apart therefrom, fifth member 20 fixedly secured to second bar member 16 and also arranged parallel to and spaced apart from fourth member 19, and, sixth member 21 arranged substantially parallel to the middle section of the first bar member and spaced apart therefrom, sixth member 21 fixedly secured to the third bar member 18 and also arranged parallel to and spaced apart from fourth member 19. Optional strap 22, secured by buckle 23, is shown securing the frame to headrest 130. The strap may or may not be necessary, depending on the number and cumulative weight of the tools to be held by the organizer. When in place, the strap provides additional support for the frame and helps to maintain the frame in a substantially parallel orientation to the ground (not shown) upon which the vehicle rests.

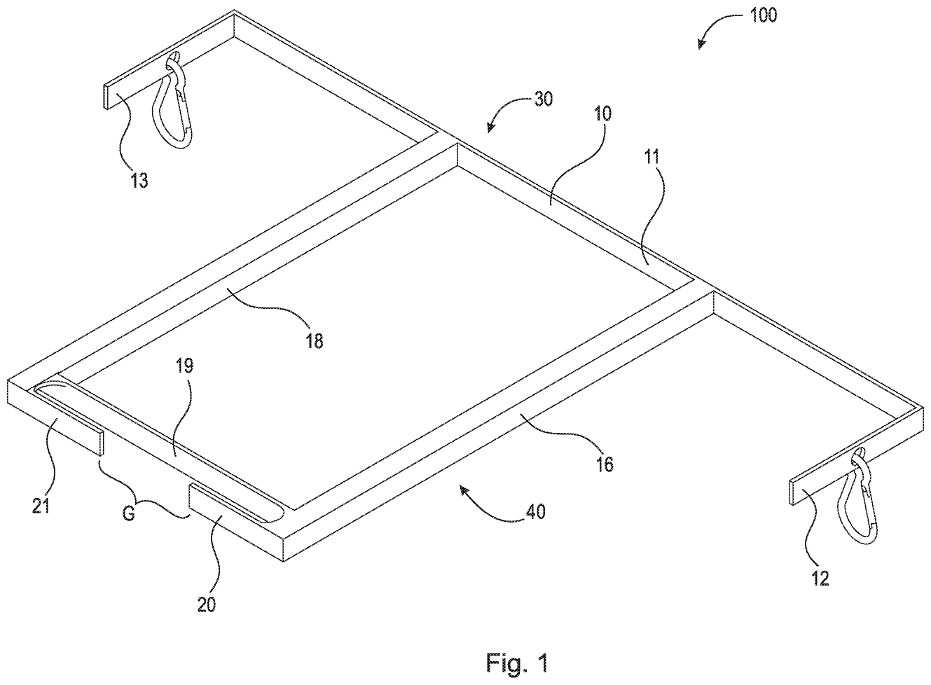

FIG. 1 is a perspective view of the tool organizer shown detached from the headrest of the vehicle. This view shows first U-shaped member 30 and second U-shaped member 40, fixedly secured to and facing one another. Again, member 30 is comprised of first section 12, second section 13 and middle section 11 arranged between the first and second sections. Member 40 is comprised of second member 16 arranged perpendicularly to said middle section 11 and fixedly secured thereto at a first location of said middle section 11, third member 18 arranged perpendicularly to said middle section 11 and fixedly secured thereto at a second location of said middle section 11, such that said second and third members are substantially parallel to and spaced apart from one another, fourth member 19 arranged substantially parallel to and spaced apart from said middle section 11 of said first member 30 and substantially parallel to said ground, said fourth member fixedly secured to said second member 16 and also fixedly secured to said third member 18, fifth member 20 arranged substantially parallel to said middle section 11 of said first member and spaced apart therefrom, said fifth member 20 fixedly secured to said second member 16 and also arranged parallel to and spaced apart from said fourth member 19. Note that, in a preferred embodiment, members 11, 12, 13, 19 and 20 are made of flat metal bar, while members 16 and 18 are made of rectangular or square metal bar (hollow or solid). These shapes of the members are representative only. Other shapes could be used and so these particular preferred shapes and compositions should not be viewed as limiting with respect to the appended claims.

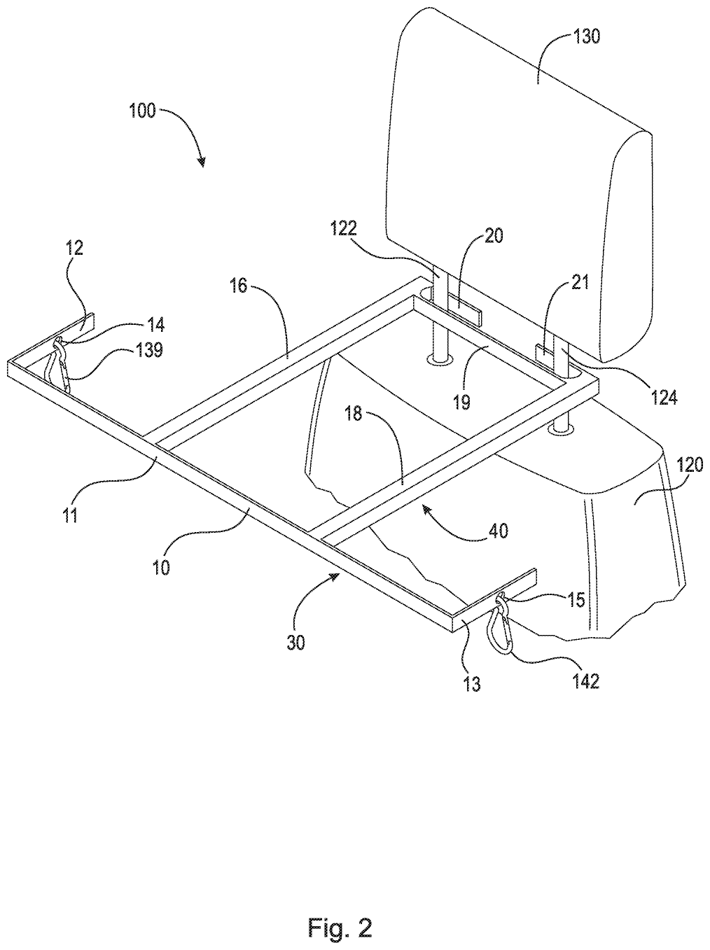

FIG. 2 is a view similar to that of FIG. 3, except showing headrest 130 in a raised position to show headrest posts 122 and 124, respectively. The tools have been omitted from this view to better show the tool organizer. Note that both FIGS. 1 and 2 show optional carabiners 139 and 142 removably secured to the frame at apertures 14 and 15, respectively. Aperture 14 is in first section 12 of first member 30 and aperture 15 is in second section 13 of first member 30, respectively. The carabiners function to suspend and hold tools to the frame. It should be appreciated that the carabiners offer one convenient way to suspend and hold tools from the frame. They function to space the tools apart from one another and prevent them from sliding along members of the frame. It should also be appreciated, however, that tools can be suspended directly from any section of first member 30 or second member 40.

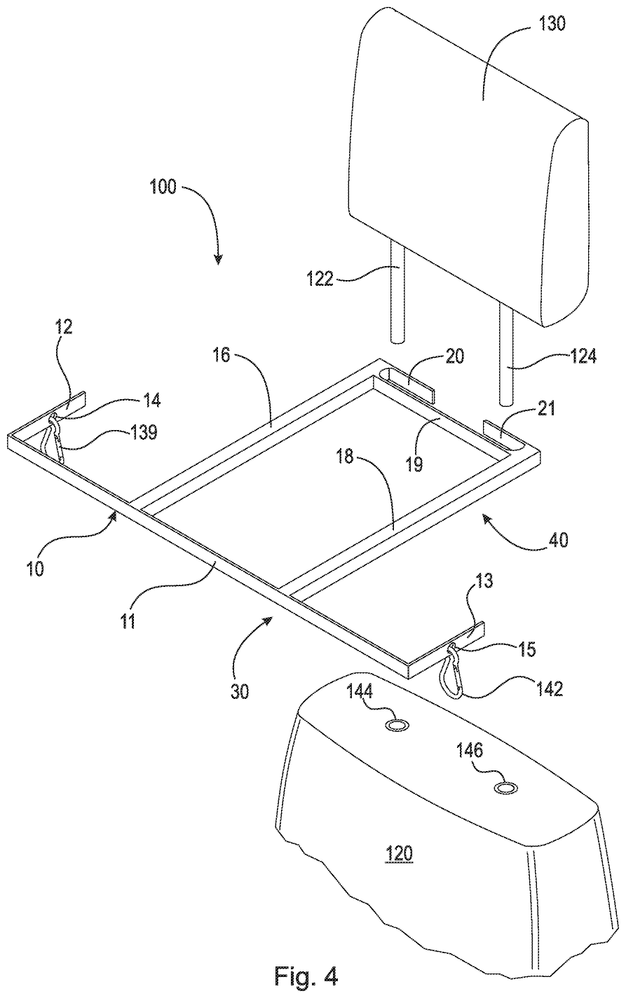

FIG. 4 is an exploded view of the tool organizer shown in FIG. 2. This view shows the headrest removed from the seatback to expose first headrest post aperture 144 and second headrest post aperture 146, which engage first headrest post 122 and second headrest post 124, respectively. It should be appreciated from this drawing especially that a gap between fifth flat bar member 20 and sixth flat bar member 21 and slots between members 19 and 20, and 19 and 21, respectively, permit easy placement of the frame about the headrest posts, and also accommodate posts in different locations (different spaces between one another) in different vehicles. For example, it is know that the distance between headrest posts in vehicles varies in a range of approximately 5″-8″ and this gap/slot arrangement in the frame accommodates easy installation of the organizer in different vehicles.

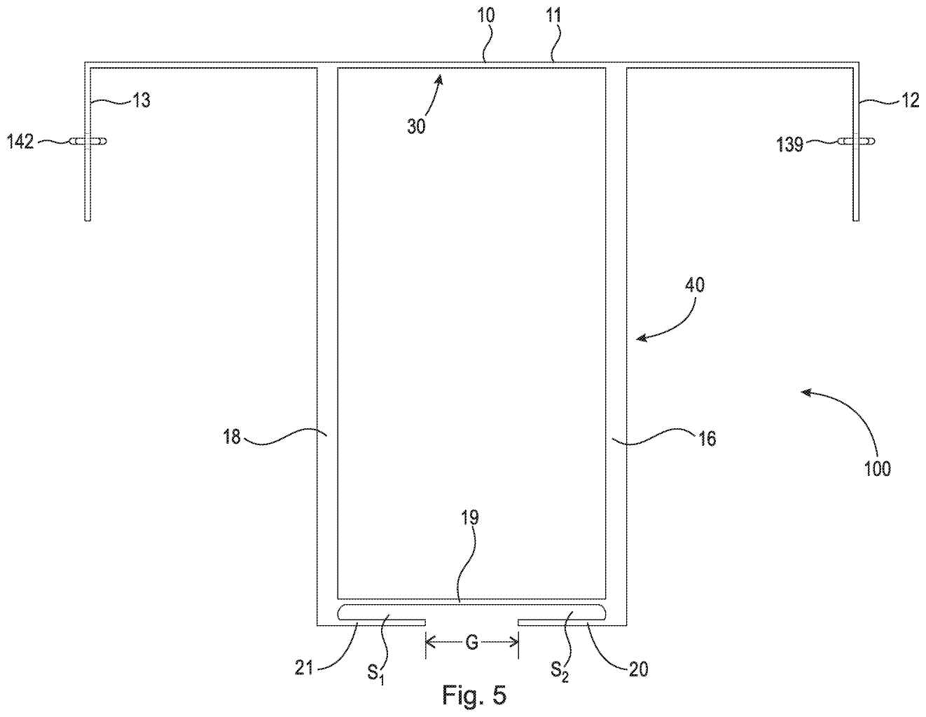

FIG. 5 is a top view of the tool organizer shown in FIG. 4. This view shows the parallel and perpendicular relationship of the various frame members and also shows gap G between members 20 and 21, slot S₁ between members 19 and 21, and slot S₂ between members 19 and 20. As described supra, this gap and these slots function to permit easy placement of the frame about headrest posts in different vehicles, since the distance between headrest posts varies among vehicle makes and models.

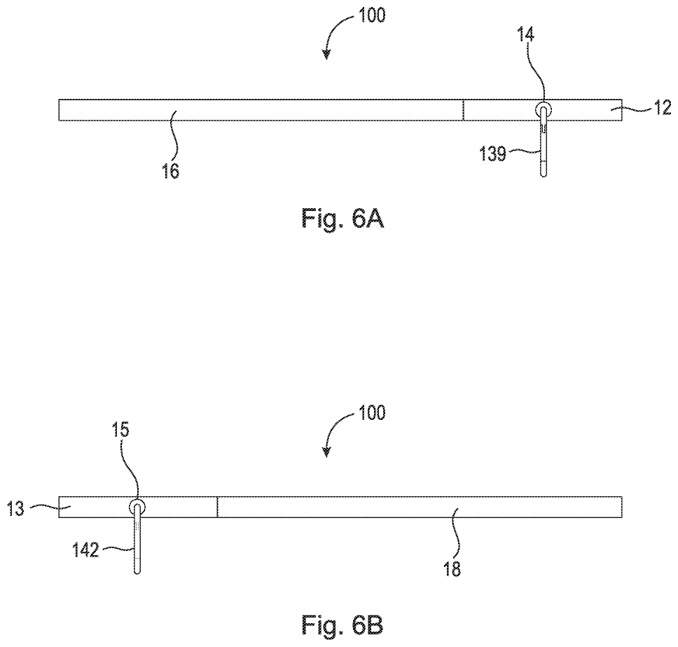

FIG. 6A is a right elevational view of the tool organizer shown in FIG. 4.

FIG. 6B is a left elevational view of the tool organizer shown in FIG. 4.

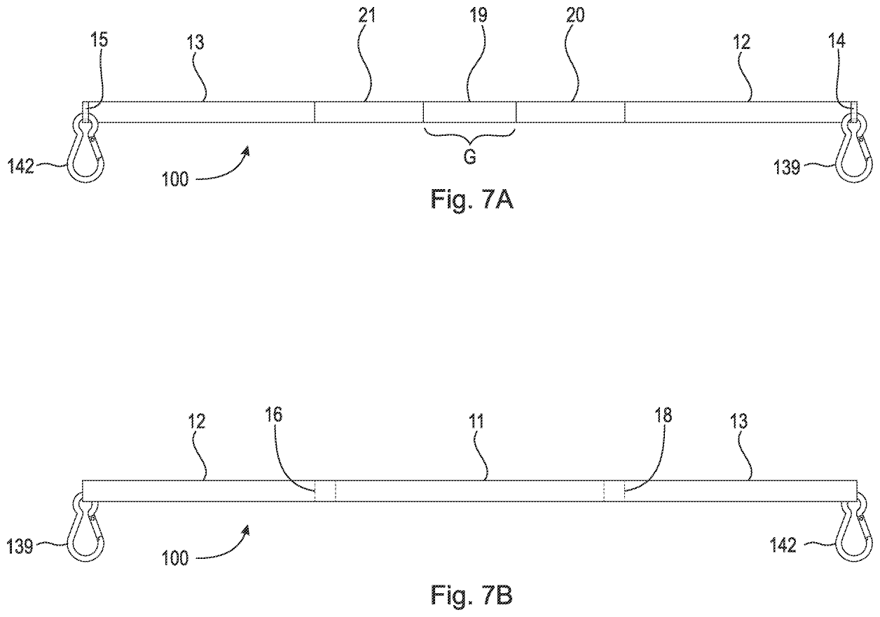

FIG. 7A is a rear elevational view of the tool organizer shown in FIG. 4.

FIG. 7B is a front elevational view of the tool organizer shown in FIG. 4.

It will be appreciated that various aspects of the present invention and other features and functions, or alternatives thereof, may be desirably combined into many other different systems or applications. For example, although a preferred embodiment of the organizer of the present invention is made of metal of various stocks, (e.g., flat bar, rectangular/square bar), it should be appreciated that the frame of the organizer could be made of other materials, such as, but not limited to, wood and plastic.

### LIST OF REFERENCE NUMERALS

100 Tool organizer
10 Frame
11 Middle section of member 30
12 First section of member 30
13 Second section of member 30
14 Aperture in first section 12 of member 30
15 Aperture in second section 13 of member 30
16 Second bar member
18 Third bar member
19 Fourth flat bar member
20 Fifth flat bar member
21 Sixth flat bar member
22 Strap
23 Buckle
30 First U-shaped member
40 Second U-shaped member
120 Seatback
122 First headrest post
124 Second headrest post
130 Headrest
135 First power screwdriver/drill
136 Stapler
138 Second power screwdriver/drill
139 First carabiner
141 Tool strap
142 Second carabiner
144 First headrest post aperture
146 Second headrest post aperture
G Gap between members 20 and 21
S₁ Slot between members 19 and 21
S₂ Slot between members 19 and 20

What I claim is:

1. A tool organizer (100) for a vehicle, comprising:
a frame (10), said frame comprising:
a first U-shaped member (30) arranged perpendicularly to ground, said first U-shaped member having a first section (12), a second section (13) and a middle section (11) arranged between said first and second sections, wherein said first and second sections are arranged parallel and in registration with one another and substantially perpendicular to said middle section;
a second member (16) arranged perpendicularly to said middle section (11) and fixedly secured thereto at a first location of said middle section (11);
a third member (18) arranged perpendicularly to said middle section (11) and fixedly secured thereto at a second location of said middle section (11), such that said second and third members are substantially parallel to and spaced apart from one another;
a fourth member (19) arranged substantially parallel to and spaced apart from said middle section (11) of said first member (30) and substantially parallel to said ground, said fourth member fixedly secured to said second member (16) and also fixedly secured to said third member (18);
a fifth member (20) arranged substantially parallel to said middle section of said first member and spaced apart therefrom, said fifth member (20) fixedly secured to said second member (16) and also arranged parallel to and spaced apart from said fourth member (19); and,
a sixth member (21) arranged substantially parallel to said middle section (11) of said first member (30) and spaced apart therefrom, said sixth member (21) fixedly secured to said third member (18) and also arranged parallel to and spaced apart from said fourth member (19).

2. The tool organizer recited in claim 1, further comprising a strap (22) operatively arranged to secure said frame (10) to a headrest (130) of said vehicle.

3. The tool organizer recited in claim 1, wherein said first U-shaped member (30) comprises a flat bar.

4. The tool organizer recited in claim 1, wherein said second member (16) comprises a rectangular bar.

5. The tool organizer recited in claim 1, wherein said third member (18) comprises a rectangular bar.

6. The tool organizer recited in claim 1, wherein said fourth member (19) comprises a flat bar.

7. The tool organizer recited in claim 1, wherein said fifth member (20) comprises a flat bar.

8. The tool organizer recited in claim 1, wherein said sixth member (21) comprises a flat bar.

9. The organizer recited in claim 1, wherein said fifth and sixth members are arranged in space so as to form a gap (G) therebetween.

10. The organizer recited in claim 1, wherein said third and fifth members are arranged parallel to and spaced apart from one another so as to form a slot (S₂) therebetween.

11. The organizer recited in claim 1, wherein said third and sixth members are arranged parallel to and spaced apart from one another so as to form a slot (S₁) therebetween.

12. The organizer recited in claim 1, wherein said second member (16), said third member (18), and said fourth member (19) form a second U-shaped member (40).

13. A tool organizer for a vehicle, comprising a frame, said frame comprising:
a first U-shaped member (30), and,
a second U-shaped member (40) facing and fixedly secured to said first U-shaped member, said second U-shaped member arranged to engage headrest posts in the vehicle.
